(19) United States
(12) Patent Application Publication
(10) Pub. No.: US 2007/0288627 A1
(43) Pub. Date: Dec. 13, 2007

(54) Method for sensing user presence for buddy list applications

(76) Inventors: Alicia Abella, Morristown, NJ (US); Brian Amento, Morris Plains, NJ (US); Lawrence Stead, Montclair, NJ (US); Benjamin J. Stern, Morris Township, NJ (US); Ganesh K. Subramaniam, Bridgewater, NJ (US)

Correspondence Address: AT&T CORP., ROOM 2A207, ONE AT&T WAY, BEDMINSTER, NJ, 07921, US

(21) Appl. No.: 11/451,790

(22) Filed: Jun. 13, 2006

(51) Int. Cl. G06F 15/173

(52) U.S. Cl. 709/224

(57) ABSTRACT

A method and system for sensing and reporting various types of user presence using “buddy list” applications. A buddy list client senses various types of user presence of a user and sends status information corresponding to the sensed user presence to a server. The buddy list client also receives status information from the server corresponding to various types of user presence information of buddies, and displays a buddy list indicating the various types of user presence information of the buddies. This can be implemented on an IPTV client in order to sense and display presence information relating to a user watching television.

### BACKGROUND OF THE INVENTION

The present invention is generally directed to sensing and reporting user presence using “buddy list” applications. More specifically, the present invention is directed to sensing and reporting various types of user presence at a user device using buddy lists to enhance various entertainment services.

Conventional buddy list applications, as used in instant messaging applications, display a list of “buddies” of an instant messaging user. The buddies are other instant messaging users that the instant messaging user has selected. Conventional buddy list applications also display an indicator for each buddy to indicate the presence of that buddy. In conventional buddy list application, presence of a buddy indicates that the buddy is logged in to the instant messaging application that the user is also logged into. When a buddy list indicates presence of a buddy of a user (i.e., that the buddy is logged in), the user can act on the presence to start an instant messaging session with the present buddy.

Although the conventional notion of user presence and the action associated with user presence allow buddy lists to be useful for instant messaging applications, this fails to take advantage of emerging entertainment and business technologies and services, such as Internet Protocol Television (IPTV), digital cable television, Voice over Internet Protocol (VoIP), network enable digital music players, etc. For example, IPTV is a service in which television programming is delivered to consumers via a data network (e.g., the Internet) using Internet Protocol. More particularly, in IPTV, television programming is delivered as video content, which is divided into data packets and streamed to consumers over the Internet. The data packets are received by an IPTV client, such as a set top box, which is connected to a consumer's television. Typically, IPTV clients connect to the Internet over a broadband connection.

IPTV provides greater control and flexibility to consumers than traditional TV distribution technologies. For example, because television programming is delivered point-to-point from a provider to a consumer, a consumer may individually control (i.e., pause, rewind, etc.) programming being delivered. Also, because television programming is being delivered over the Internet, a consumer may receive IPTV programming from around the world. Additionally, IPTV can be provided with other Internet services, such as Voice over IP (VOIP) services. An IPTV receiver can also be used in conjunction with or function as a digital video receiver (DVR) to record and store IPTV programming.

### BRIEF SUMMARY OF THE INVENTION

The present invention provides a method and system for sensing various types of user presence at various user devices and reporting various types of user presence using buddy lists in order to enhance various entertainment and business services and technologies. This can be achieved by sensing various types of user presence at a buddy list client device, transmitting status information corresponding to the sensed user presence to a server, and receiving status information from the server corresponding to various types of user presence sensed at other buddy list client devices, and displaying a buddy list indicating the user presence at the other buddy list client devices.

According to various embodiments of the present invention, the buddy list shows status information corresponding to various types of user presence of buddies, such as television presence, telephone presence, physical presence, and presence of shared content on a buddy list client. In response to the buddy list indicating some form of user presence for a buddy, a user can initiate various actions, such watching the same channel or program as a buddy, initiating a Voice over Internet Protocol (VoIP) telephone call to a buddy, initiate an email to a buddy, initiating an instant messaging session with a buddy, or viewing playing play a buddy's shared content.

IPTV is an example of a service that can be used to implement an embodiment of the present invention. Because IPTV delivers television programming over the Internet, there are many possible ways to utilize the Internet to enhance consumers' viewing experience. Collaborative viewing, in which consumer's in different locations experience IPTV viewing together, is one way to enhance the IPTV viewing experience. Accordingly, it is desirable to provide a way for users to easily interact with each other while viewing IPTV. The present invention allows users of Internet Protocol Television (IPTV) to easily interact with each other while viewing IPTV. This is accomplished by displaying a buddy list for each user of an IPTV client. The buddy list shows buddies of a user and user presence information for each buddy. A user can use the buddy list to interact with the buddies by selecting icons relating to various types of user presence.

In one embodiment of the present invention, an IPTV client senses user presence of a user and transmits status information corresponding to the sensed user presence to a server. The server determines which users of other IPTV clients list the user as a buddy, and sends the status information to the other IPTV clients. When an IPTV client receives status information from the server, the IPTC client displays a buddy list indicating the user presence of the buddies.

These and other advantages of the invention will be apparent to those of ordinary skill in the art by reference to the following detailed description and the accompanying drawings.

### BRIEF DESCRIPTION OF THE DRAWINGS

FIG. 1 illustrates an Internet Protocol Television (IPTV) system configured to implement an embodiment of the present invention;

FIG. 2 illustrates a high level block diagram of a computer capable of implementing the present invention;

FIG. 3 illustrates an exemplary buddy list displayed by an IPTV client;

FIG. 4 illustrates a method of controlling an IPTV client according to an embodiment of the present invention;

FIG. 5 illustrates an exemplary method of sensing various types of presence information according to an embodiment of the present invention; and

FIG. 6 illustrates an exemplary method of using a buddy list to trigger a variety of actions according to an embodiment of the present invention.

### DETAILED DESCRIPTION

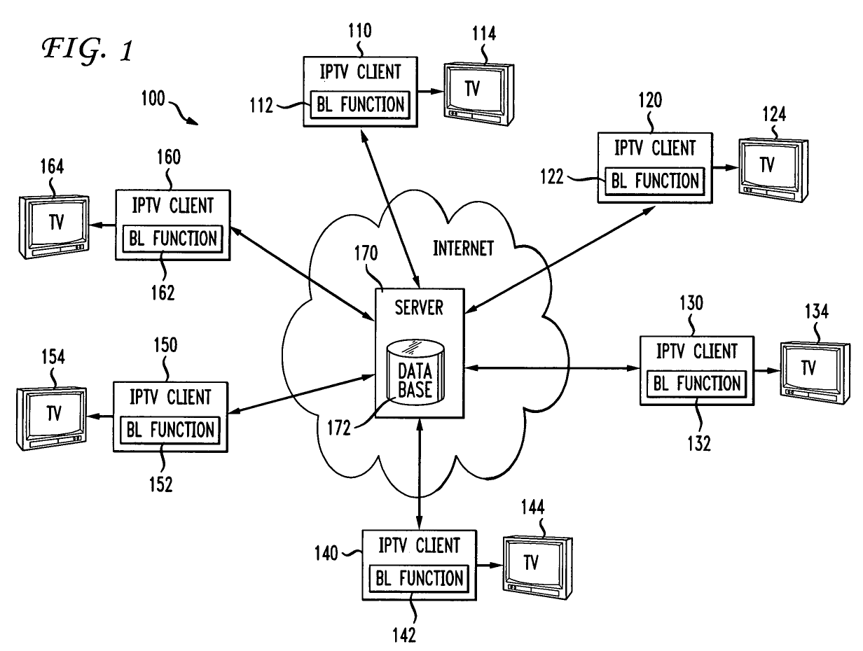

The present invention is directed to sensing and reporting various types of user presence at a buddy list client device. A buddy list client device refers to any type of device capable of displaying a buddy list or any device for which some type of user presence can be sensed and displayed in a buddy list on another device. User presence refers to any way in which a user of a buddy list client device is directly or indirectly interacting with the buddy list client device. Examples of various types of user presence are described in greater detail below Examples of buddy list client devices can include, but are not limited to, Internet Protocol Television (IPTV) clients, digital cable receivers, personal computers (PCs), personal digital assistants (PDAs), digital video recorders (DVRs), digital music players, etc. FIG. 1 illustrates an Internet Protocol Television (IPTV) system 100 configured to implement an embodiment of the present invention. However, the present invention is not limited to being implemented as illustrated in FIG. 1, but may be implemented using any buddy list client device or combination of buddy list client devices.

As illustrated in FIG. 1, the IPTV system 100 includes a plurality of IPTV clients 110, 120, 130, 140, 150, and 160 which communicate with a server 170 via the Internet. The IPTV clients 110, 120, 130, 140, 150, and 160 can be embodied as set top boxes, which respectively connect to televisions (TV) 114, 124, 134, 144, 154, and 164. The IPTV clients 110, 120, 130, 140, 150, and 160 receive television programming from an IPTV service provider via the Internet. The television programming is transmitted to the IPTV clients 110, 120, 130, 140, 150, and 160 over the Internet in the form of data packets using Internet Protocol (IP). The IPTV clients 110, 120, 130, 140, 150, and 160 receive the data packets, convert the data packets to video signals, and transmit the video signals to the respective TVs 114, 124, 134, 144, 154, and 164 in order for the television programming to be viewed by users. Although FIG. 1 depicts TVs 114, 124, 134, 144, 154, and 164 being used to display the television programming, any display device capable of displaying the video signals transmitted from an IPTV client may also be used. Furthermore, Although FIG. 1 illustrates IPTV clients 110, 120, 130, 140, 150, and 160 respectively connected to separate TVs 114, 124, 134, 144, 154, and 164, the present invention is not limited thereto. For example, an IPTV client and a display may be provided in the same device.

The IPTV clients 110, 120, 130, 140, 150, and 160 respectively include buddy list functions 112, 122, 132, 142, 152, and 162, which display buddy lists on the respective TVs 114, 124, 134, 144, 154, and 164. A user of an IPTV client 110, 120, 130, 140, 150, and 160 can have a corresponding buddy list which is displayed on the user's TV 114, 124, 134, 144, 154, and 164. The buddy list for a particular user displays a list of buddies (i.e., users of other IPTV clients) selected by the user, and shows status information for each buddy. The status information for a buddy can reflect user presence of the buddy on an IPTV client. The buddy lists of the users of each IPTV client 110, 120, 130, 140, 150, and 160 are stored in a database 172 on the server 170.

The IPTV clients 110, 120, 130, 140, 150, or 160 sense user presence and send status information to the server 170 corresponding to the sensed user presence. User presence, as described above, refers to any direct or indirect interaction between a user and an IPTV client (or any other buddy list client). Examples of various types of user presence are described in greater detail below. The server 172 sends the status information to the IPTV clients 110, 120, 130, 140, 150, and 160 to be displayed on the buddy lists to reflect the user activity of the buddies in the buddy lists displayed by the IPTV clients 110, 120, 130, 140, 150, and 160. For example, if there is a change in the user presence on IPTV client 110, IPTV client 110 sends status information indicating the change in user presence to the server 170. The server 170 then checks the database 172 to determine which users of the other IPTV clients 120, 130, 140, 150, and 160 list the user of IPTV client 110 as a buddy. If the users of IPTV clients 120 and 130 list the user of IPTV client 110 as a buddy, the server sends the status information to IPTV clients 120 and 130, and IPTV clients 120 and 130 update the buddy lists displayed on TVs 124 and 134, respectively, to display the status information in order to reflect the change in user presence on IPTV client 110.

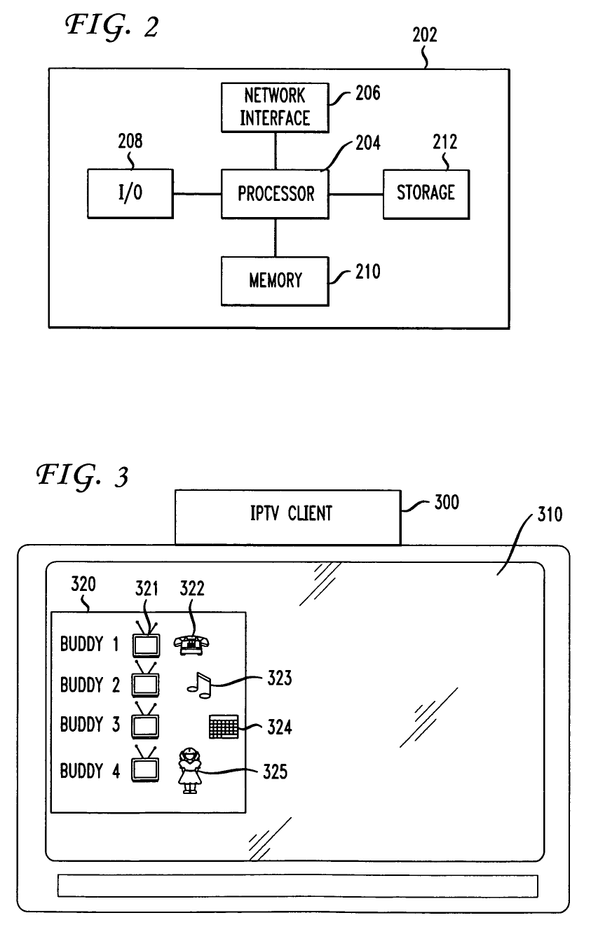

A buddy list client, such as the IPTV clients of FIG. 1, having the buddy list functionality described herein may be implemented on a computer using well known computer processors, memory units, storage devices, computer software, and other components. A high level block diagram of such a computer is illustrated in FIG. 2. Computer 202 contains a processor 204 which controls the overall operation of the computer 202 by executing computer program instructions which define such operation. The computer program instructions may be stored in a storage device 212 (e.g., magnetic disk) and loaded into memory 210 when execution of the computer program instructions is desired. Thus, the buddy list function can be defined by the computer program instructions stored in the memory 210 and/or storage 212 and the buddy list function will be controlled by the processor 204 executing the computer program instructions. The computer 202 also includes one or more network interfaces 206 for communicating with other devices via a network. The computer 202 also includes input/output 208 which represents devices which allow for user interaction with the computer 202 (e.g., display, keyboard, mouse, speakers, buttons, etc.) The computer 202 may be provided in the form of a set-top box added functionality of the elements of FIG. 2. In the case of the buddy list client being an IPTV client, a digital cable receiver or the like, a user may interact with the computer 202 using a remote control. One skilled in the art will recognize that an implementation of an actual computer will contain other components as well, and that FIG. 2 is a high level representation of some of the components of such a computer for illustrative purposes.

In addition to an IPTV client, other types of buddy list client devices (i.e., computer devices) may be used to perform various functions, such as Voice over Internet Protocol (VoIP) telephone calling, email, storing audio and video files, and a calendar function. It is also possible that one buddy list client device, such as an IPTV client or a PC, be able to perform multiple functions. Accordingly, the buddy list can display status information that reflects a variety of types of user presence associated with different functions being performed by buddy list client devices associated with buddies. These types of presence can include, but are not limited to, whether a buddy is watching TV, what channel a buddy is watching, what program a buddy is watching, whether a buddy is currently on a VoIP telephone call, whether new audio or video content is stored on a buddy's device (i.e., computer, IPTV set top box, or other network device), and whether a new appointment is stored in a buddy's calendar. Additionally, a computer, IPTV client, wireless router, or other network-enabled computing device can be equipped to detect whether a registered wireless device of a user is within a limited range in order to detect physical presence of the user. A registered wireless device refers to any device that has wireless connectivity with a limited range, such as RFID, Bluetooth, WiFi, etc. Accordingly, in order to detect a registered wireless device, wireless functionality (e.g., antenna, radio, etc.) can be added to the buddy list client. When the buddy list client detects the registered wireless device of a user within its range, status information indicating physical presence of the user at the buddy list client can be displayed on buddy lists where the user is a buddy.

FIG. 3 illustrates an exemplary buddy list 320 being displayed on a display 310 (e.g., television) by an IPTV client 300. As illustrated in FIG. 3, the buddy list includes a list of user names (buddy1, buddy2, buddy3, and buddy4) and status information for each user name. The status information is displayed using icons representing different types of user presence. For example, a television presence icon 321 indicates that a buddy's TV is currently on, a telephone presence icon 322 indicates that a buddy is currently on a VoIP telephone call, an audio file presence icon 323 indicates that a buddy has stored a new audio file, an appointment presence icon 324 indicates that a new appointment has been added to a buddy's calendar, and a physical presence icon 325 indicates the physical presence of a buddy at an IPTV client. A user can use an input device, such as a remote control, to select a username or an icon. When a username or an icon is selected, the IPTV client 300 can automatically perform a predetermined action or can display a menu of options to allow a user to select an action. For example, if a user selects the television icon of buddy1, the IPTV client 300 can automatically set the channel of the display 310 to the channel that buddy1 is watching.

As illustrated in FIG. 3, the buddy list 320 is displayed in a window on a screen of the TV 310, but the present invention is not limited thereto. A buddy list may be displayed in a variety of other ways on a TV including on a scroll bar across the bottom of the screen or on a separate channel dedicated to the buddy list. It is also possible that a buddy list be displayed on another device, such as a desktop or laptop computer, a PDA, etc.

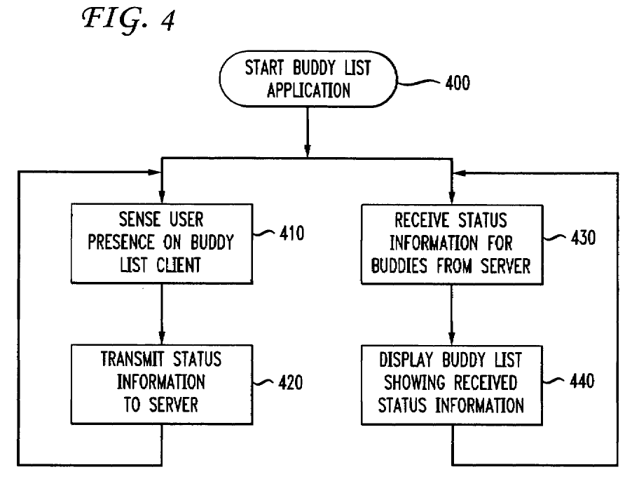

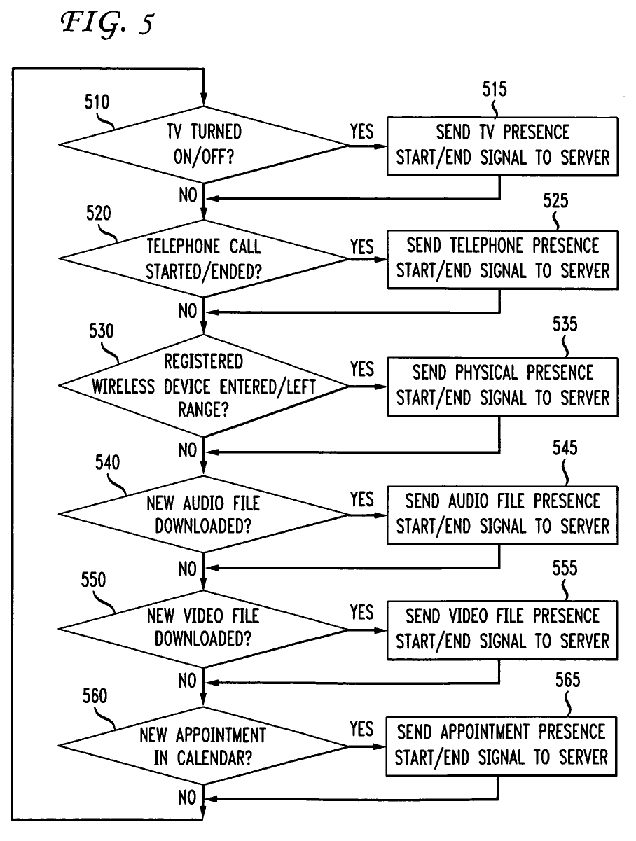

FIG. 4 illustrates a method of controlling a buddy list client according to an embodiment of the present invention. Referring to FIG. 4, at step 400, the buddy list client runs a buddy list application. The buddy list application can start automatically when the TV is turned on or can be started when a user of the buddy list client logs on to the buddy list application using a username and password. Furthermore, in the case of an IPTV client, the buddy list application can associate a single user and buddy list with an IPTV client or be configured to have separate buddy lists corresponding to plural users using the same IPTV client. When the buddy list application is started at step 400, the buddy list client proceeds to steps 410 and 430. As illustrated in FIG. 4, the buddy list client simultaneously performs steps 410 and 420 and steps 430 and 440.

At step 410, the buddy list client senses user presence. As described above, the buddy list client can sense different types of user presence. At step 420, the buddy list client transmits status information corresponding to the sensed user presence to a server via a data network, such as the Internet. The buddy list client continuously loops through steps 410 and 420 while the buddy list application is running, such that whenever there is a change to the user presence, the buddy list client senses the change in user presence (step 410) and transmits updated status information corresponding to the change in user presence to the server (step 420).

FIG. 5 illustrates an example of sensing the user presence (step 410) and transmitting the status information to the server (step 420) for a variety of types of user presence. It is to be understood that FIG. 5 is purely exemplary, and the present invention is not limited to sensing the types of user presence described therein.

Referring to FIG. 5, at step 510, the buddy list client senses whether a TV associated with the buddy list client is turned on or off, that is sensing a change in state of the television. If the TV is switched on or off at step 510, the method proceeds to step 515. If the TV is not switched on or off at step 510, the method proceeds to step 520. If the buddy list client detects that the TV is turned on, the buddy list client can also sense what channel and/or what program the TV is on. The buddy list client can also sense any change in the channel and/or the program of the TV.

At step 515, the buddy list client sends a TV presence signal to the server. If it is sensed that the TV is turned on at step 510, the buddy list client sends a TV presence start signal to the server to indicate that the TV is on. If it is sensed that the TV is turned off at step 510, the buddy list client sends a TV presence end signal to the server to indicate that the TV is off, thereby indicating that this client is no longer “present”. When the buddy list client sends the TV presence start signal, the buddy list client can also send a channel and/or a program signal to the server to indicate what channel/program the TV is on. The buddy list client can also send the channel and/or the program signal whenever a change in the channel and/or the program is sensed.

At step 520, the buddy list client senses whether a telephone call is started or ended. For example, the buddy list client can sense whether a user begins or ends a VoIP telephone call. If the buddy list client senses that a user begins or ends a telephone call at step 520, the method proceeds to step 525. If the buddy list client does not sense that a user begins or ends a telephone call at step 520, the method proceeds to step 530.

At step 525, the buddy list client sends a telephone presence signal to the server. When it is sensed that the user begins a telephone call at step 520, the buddy list client sends a telephone presence start signal to the server to indicate that the user is on the telephone. When it is sensed that the user ends a telephone call at step 520, the buddy list client sends a telephone presence end signal to the server to indicate that the user is no longer on the telephone.

At step 530, the buddy list client senses whether a registered wireless device enters or leaves a range of the IPTV client. As described above, a registered wireless device can refer to any device that has wireless connectivity with a limited range, such as RFID, Bluetooth, WiFi, etc. If the buddy list client senses that a registered wireless device enters or leaves the range of the IPTV client at step 530, the method proceeds to step 535. If the buddy list client does not sense that a registered wireless device enters or leaves the range of the buddy list client at step 530, the method proceeds to step 540.

At step 535, the buddy list client sends a physical presence signal to the server. When it is sensed that the a registered wireless device of a user enters the range of the buddy list client at step 530, the buddy list client sends a physical presence start signal to the server to indicate that the a user is physically present within the range of the IPTV client. When it is sensed that the a registered wireless device of a user leaves the range of the buddy list client at step 530, the buddy list client sends a physical presence end signal to the server to indicate that the user is no longer physically present within the range of the IPTV client.

At step 540, the buddy list client senses whether a new audio file is downloaded. The buddy list client can sense when an audio file is downloaded onto the buddy list client or downloaded onto an external device, such as an internet enabled mp3 player, which communicates with the buddy list client. If the buddy list client senses that a new audio file is downloaded at step 540, the method proceeds to step 545. If the buddy list client does not sense that a new audio file is downloaded at step 540, the method proceeds to step 550. At step 545, the buddy list client sends an audio file presence start signal to the server to indicate that a new audio file has been downloaded.

At step 550, the buddy list client senses whether a new video file is downloaded. The buddy list client can sense when video file is downloaded onto the buddy list client or downloaded onto an external device, such as an external DVR, which communicates with the buddy list client. If the buddy list client senses that a new video file is downloaded at step 550, the method proceeds to step 555. If the buddy list client does not sense that a new video file is downloaded at step 550, the method proceeds to step 560. At step 555, the buddy list client sends a video file presence start signal to the server to indicate that a new video file has been downloaded.

At step 560, the buddy list client senses whether a new appointment is added to a user's calendar application. The appointment can be added to a calendar application running on the buddy list client or on an external device, such as a PC or PDA, which communicates with the buddy list client. If the buddy list client senses that a new appointment is added to the calendar application at step 560, the method proceeds to step 565. If the buddy list client does not sense that a new appointment is added to the calendar application at step 560, the method returns to step 510. At step 565, the buddy list client sends an appointment presence start signal to the server to indicate that a new appointment has been added to the user's calendar. The method then returns to step 510, and continuously loops through steps 510-565 while the buddy list application is running.

Returning to FIG. 4, when the buddy list application is started at step 400, the buddy list client proceeds to steps 410 and 430. As illustrated in FIG. 4, the buddy list client simultaneously performs steps 410 and 420 and steps 430 and 440. At step 430, the buddy list client receives status information from the server corresponding to user presence of buddies in a user's buddy list. The status information received from the server can correspond to a variety of different presence types for a plurality of buddies. At step 440, the buddy list client displays the users buddy list, which shows the status information for each buddy that is present in some form. For example, an IPTV client can display the buddy list in a variety of different ways on a TV associated with the IPTV client, such as a window on the TV screen, a scrolling ticker at the bottom of the TV screen, and as a dedicated IPTV channel. In the case of other computer devices being used as the buddy list client, the buddy list can be displayed in a window or part of a window of the buddy list application. In this case, the buddy list can be implemented together with a traditional Instant Messaging buddy list, or provided as a separate application.

The status information for each buddy may be displayed on the buddy list with a visual representation of the types of presence active for each buddy. This may include different icons, different text colors, or another scheme to represent each type of user presence. The buddy list client continuously loops through steps 430 and 440 while the buddy list application is running, such that whenever updated status information is received for any buddies of the user of the buddy list client (step 430), the buddy list client displays an updated buddy list showing the updated status information (step 440).

When a buddy list is displayed at a display associated with a buddy list client, the user may use the buddy list to interact with buddies based on the status information displayed in the buddy list. For example, the user may select a buddy's icons to trigger actions including, but not limited to, automatically switching the channel to the same channel (or program) that a buddy is watching, launching a VoIP telephone call, an email, or an instant messaging session with a buddy, initiating a conference call among more than one buddy, playing an audio or video file shared by a buddy, or viewing appointments on a buddy's calendar.

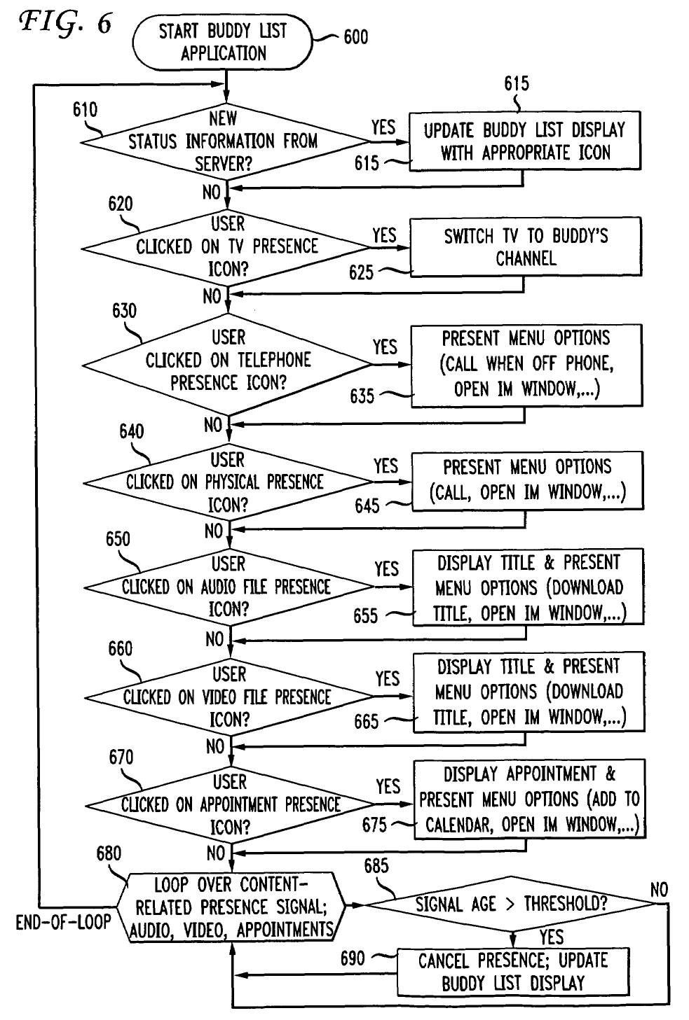

FIG. 6 illustrates an example of using a buddy list to trigger a variety of actions. Referring to FIG. 6, at step 600, a buddy list client runs a buddy list application. At step 610, the buddy list client determines whether new status information is received from the server. If new status information is received from the server at step 610, the method proceeds to step 615. If no new status information is received from the server at step 610, the method proceeds to step 620. At step 615, the buddy list client updates the buddy list by displaying (or removing) appropriate icons corresponding to the new status information received from the server.

At step 620, the buddy list client detects whether a user selects a TV presence icon of a buddy in the buddy list. If a TV presence icon is selected at step 620, the method proceeds to step 625. If no TV presence icon is selected at step 620, the method proceeds to step 630. At step 625, a buddy list client, such as an IPTV client or a digital cable receiver, automatically switches the user's TV to the same channel as the TV of the buddy whose TV presence icon is selected at step 620. Alternatively, the buddy list client can automatically switch the user's TV to the same program that the buddy is watching.

At step 630, the buddy list client detects whether the user selects a telephone presence icon of a buddy. If a telephone presence icon is selected at step 630, the method proceeds to step 635. If no telephone presence icon is selected at step 630, the method proceeds to step 640. At step 635, the buddy list client displays menu options corresponding to the telephone presence icon. These menu options can include initiating a VoIP call to the buddy when the buddy gets off the phone, initiating an instant messaging session with the buddy, sending an email to the buddy, etc. When the user selects a menu option, the buddy list client performs the action corresponding to the selected menu option, or controls an external device communicating with the buddy list client to perform the action.

At step 640, the buddy list client detects whether the user selects a physical presence icon of a buddy. If a physical presence icon is selected at step 640, the method proceeds to step 645. If no physical presence icon is selected at step 640, the method proceeds to step 650. At step 645, the buddy list client displays menu options corresponding to the physical presence icon. These menu options can include initiating a VoIP call to the buddy, initiating an instant messaging session with the buddy, sending an email to the buddy, etc. When the user selects a menu option, the buddy list client performs the action corresponding to the selected menu option, or controls an external device communicating with the buddy list client to perform the action.

At step 650, the buddy list client detects whether the user selects an audio file presence icon of a buddy. If an audio file presence icon is selected at step 650, the method proceeds to step 655. If no audio file presence icon is selected at step 650, the method proceeds to step 660. At step 655, the buddy list client displays menu options corresponding to the audio file presence icon. These menu options can include downloading the same audio file, playing the audio file, initiating a VoIP call to the buddy, initiating an instant messaging session with the buddy, sending an email to the buddy, etc. When the user selects a menu option, the buddy list client performs the action corresponding to the selected menu option, or controls an external device communicating with the buddy list client to perform the action.

At step 660, the buddy list client detects whether the user selects a video file presence icon of a buddy. If a video file presence icon is selected at step 660, the method proceeds to step 665. If no video file presence icon is selected at step 660, the method proceeds to step 670. At step 665, the buddy list client displays menu options corresponding to the video file presence icon. These menu options can include downloading the same video file, playing the video file, initiating a VoIP call to the buddy, initiating an instant messaging session with the buddy, sending an email to the buddy, etc. When the user selects a menu option, the buddy list client performs the action corresponding to the selected menu option, or controls an external device communicating with the buddy list client to perform the action.

At step 670, the buddy list client detects whether the user selects an appointment presence icon of a buddy. If an appointment presence icon is selected at step 670, the method proceeds to step 675. If no appointment presence icon is selected at step 670, the method proceeds to step 680. At step 675, the buddy list client displays menu options corresponding to the appointment presence icon. These menu options can include viewing the buddy's calendar, adding the appointment to the user's calendar, initiating a VoIP call to the buddy, initiating an instant messaging session with the buddy, sending an email to the buddy, etc. When the user selects a menu option, the buddy list client performs the action corresponding to the selected menu option, or controls an external device communicating with the buddy list client to perform the action.

At step 680, the buddy list client performs a loop over the content related presence signals (i.e., the audio file presence signal, the video file presence signal, and the appointment presence signal) received from the server. That is, the buddy list client only displays icons corresponding to these presence signals on the buddy list for a limited amount of time so that icons are only displayed for new content. Accordingly, at step 685, the buddy list client determines whether the age of a content related presence signal (i.e., how long it has been since the signal was received from the server) is greater than a threshold. If the age of the content related signal is greater than the threshold at step 685, the method proceeds to step 690. At step 690, the buddy list client cancels the presence of the content and updates the buddy list to remove the corresponding icon. While the buddy list application is running the buddy list client continuously loops through steps 610-690.

Although the method of FIG. 6, describes displaying icons related to content (i.e., audio file, video file, and appointment) presence for a limited amount of time, the present invention is not limited thereto. For example, the content presence icons can be displayed until selected by a user, and then cleared. It is also possible that the content presence icons only be displayed when displaying other presence icons.

As described above, the present invention allows a user to view status information indicating various types of user presence of buddies listed on the users buddy list. In an embodiment of the present invention, a user can select what information is available to those who list the user on their buddy lists, in order to protect the user's privacy.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
sensing a plurality of types of user presence at a buddy list client device;
transmitting status information corresponding to each of the sensed plurality of types of user presence to a server;
receiving status information from the server corresponding to a plurality of types of user presence sensed at least one other buddy list client device; and
displaying a buddy list indicating the user presence at the at least one other buddy list client device.

2. The method of claim 1, wherein said buddy list client device comprises at least one of an Internet Protocol Television (IPTV) client, a digital cable receiver, a computer, a personal digital assistant, a digital music player, and a digital video recorder.

3. The method of claim 1, wherein said plurality of types of user presence comprises:
an on/off state of a television associated with a buddy list client device.

4. The method of claim 3, wherein said plurality of types of user presence further comprises at least one of:
a channel that the television associated with the buddy list client is tuned to; and
a program that the television associated with the buddy list client is tuned to.

5. The method of claim 1, wherein said sensing step comprises:
sensing whether a user is logged into said buddy list client.

6. The method of claim 1, wherein said sensing step comprises:
sensing whether a Voice over Internet Protocol (VoIP) call is in progress.

7. The method of claim 1, wherein said sensing step comprises:
sensing whether a registered wireless device of a user exists within a predetermined range of the buddy list client.

8. The method of claim 1, wherein said sensing step comprises:
sensing newly stored content.

9. The method of claim 8, wherein said newly stored content comprises at least one of:
a newly stored audio file;
a newly stored video file; and
a newly added appointment in a calendar application.

10. The method of claim 1, wherein said displaying step comprises:
displaying said buddy list using one of a window on a television screen, a scrolling ticker on a television screen, a dedicated IPTV channel, a computer screen, and a display of a handheld device.

11. The method of claim 1, wherein said displaying step comprises:
displaying visual indications representing said plurality of types of user presence.

12. The method of claim 11, wherein said visual indications comprise at least one of icons corresponding to said plurality of types of user presence and different colors of text corresponding to said plurality of types of user presence.

13. The method of claim 11, further comprising:
performing an action in response to a user selection of a displayed visual indication.

14. The method of claim 13, wherein said action comprises:
setting a television associated with said buddy list client device to a channel that a television associated with said at least one other buddy list client device is tuned to.

15. The method of claim 13, wherein said action comprises:
initiating one of a Voice over Internet Protocol (VoIP) call, an email, and an instant messaging session to said at least one other buddy list client.

16. The method of claim 1, further comprising:
receiving updated status information corresponding to a change in the user presence at said at least one other IPTV client; and
updating the displayed buddy list to reflect the change in the user presence at the at least one other buddy list client.

17. A method comprising:
sensing user presence at a buddy list client device, said user presence corresponding to at least one of status of a television associated with said buddy list client device, whether a Voice over Internet Protocol (VoIP) call is in progress, physical presence of a registered wireless device of a user within a predetermined range of said buddy list client device, and newly stored content;
transmitting status information corresponding to the sensed user presence to a server;
receiving status information from the server corresponding to user presence sensed at least one other buddy list client device; and
displaying a buddy list indicating the user presence at the at least one other buddy list client device.

18. The method of claim 17, wherein said status of a television associated with said buddy list client device comprises at least one of:
an on/off state of said television;
a channel of said television; and
a program that said television is tuned to.

19. The method of claim 17, wherein said newly stored content comprises at least one of:
a newly stored audio file;
a newly stored video file; and
a newly added appointment in a calendar application.

20. A buddy list client device, comprising:
means for sensing a plurality of types of user presence;
means for transmitting status information corresponding to the sensed plurality of types of user presence to a server;
means for receiving status information from the server corresponding to a plurality of types of user presence of at least one buddy; and
means for displaying a buddy list indicating said plurality of types of user presence of at least one buddy.

21. The buddy list client device of claim 20, wherein said sensing means comprises:
means for detecting a registered wireless device of a user within a predetermined range of said buddy list client device.

22. The buddy list client device of claim 20, wherein said displaying means comprises:
means for connecting to a display device to display the buddy list on the display device.

23. The buddy list client device of claim 20, further comprising:
means for receiving one of Internet Protocol Television (IPTV) programming and digital cable programming; and
means for playing said received one of IPTV programming and digital cable programming.

24. The buddy list client device of claim 20, further comprising:
means for initiating at least one of a Voice over Internet Protocol (VoIP) call, an email, and an instant messaging session.

25. The buddy list client device of claim 20, further comprising:
means for storing at least one of audio files and video files.

26. A method of controlling buddy lists on a plurality of Internet Protocol Television (IPTV) clients, comprising:
receiving status information corresponding to user presence at an IPTV client; and
transmitting said status information to at least one other IPTV clients.

27. The method of claim 26, wherein said receiving step comprises:
receiving status information corresponding to user presence of a particular user at an IPTV client.

28. The method of claim 27, wherein said transmitting step comprises:
searching a database for at least one buddy list including said particular user; and
transmitting said status information to at least one IPTV client associated with said at least one buddy list including said particular user.

29. The method of claim 26, wherein said status information comprises a plurality of types of information corresponding to a plurality of types of user presence.
